(19) United States
(12) Patent Application Publication
(10) Pub. No.: US 2010/0037271 A1
(43) Pub. Date: Feb. 11, 2010

(54) System and Method for Receiving a Picture-in-Picture Display via an Internet Connection in a Satellite Television System

(75) Inventor: Keith Crowe, Cedar Park, TX (US)

Correspondence Address: AT&T Legal Department - LNA;Attn: Patent Docketing, Room 2A- 207, One AT & T Way, Bedminster, NJ, 07921, US

(73) Assignee: AT&T INTELLECTUAL PROPERTY I, L.P., Reno, NV (US)

(21) Appl. No.: 12/186,248

(22) Filed: Aug. 5, 2008

(51) Int. Cl. H04N 7/20

(52) U.S. Cl. 725/68; 725/63

(57) ABSTRACT

A method for receiving a picture-in-picture display via an Internet connection in a satellite television system. A first video stream associated with linear television content is received from a satellite dish. A second video stream is received over an Internet protocol connection. The first video stream of linear television content received from the satellite dish is output to a display, and the second video stream received from the Internet protocol connection is output to a picture-in-picture display on the display.

### FIELD OF THE DISCLOSURE

The present disclosure generally relates to communications networks, and more particularly relates to a system and method for receiving a picture-in-picture display via an Internet connection in a satellite television system.

### BACKGROUND

Television content may come from a cable, satellite, broadcast or other television source, or from an Internet protocol television (IPTV) network, and is typically in a standard-definition (SD) or high-definition (HD) format. The television content source for a particular customer can depend on a preference of the customer, on the location of the customer, and/or the type of network owned by the television service provider. Also, depending on the television content source the customer may be provided with ability to view television content in a picture-in-picture display.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a satellite television network with an Internet protocol connection;

FIG. 2 is a block diagram of a set-top box device;

FIG. 3 is an exemplary schematic illustration of a display device;

FIG. 4 is a flow diagram of a method for receiving both satellite linear television content and Internet protocol television content at the set-top box device; and

FIG. 5 is a block diagram of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

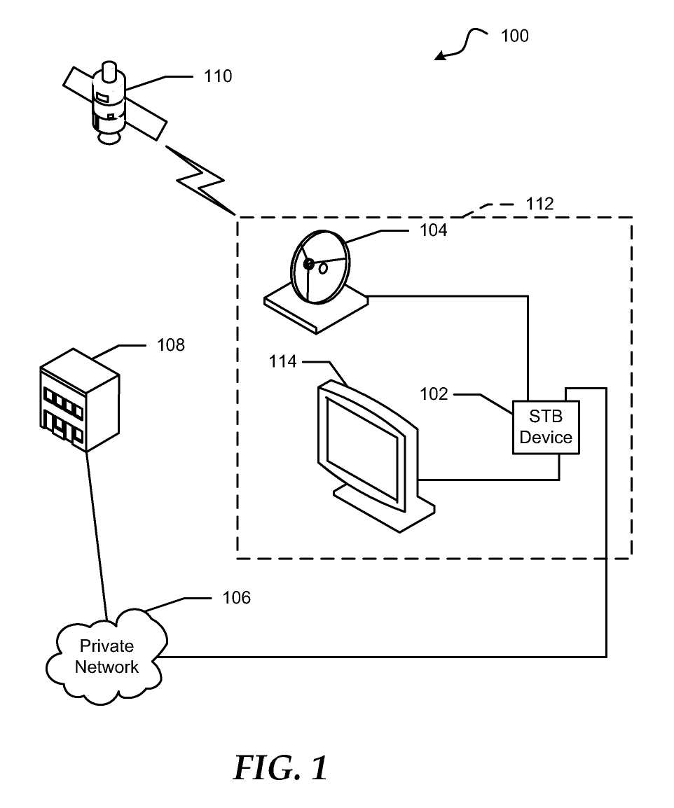

FIG. 1 shows a television system 100 including a set-top box device 102, a satellite dish 104, a private network 106, an Internet Protocol (IP) head-end office 108, and a television content satellite 110. In an embodiment, a customer premises 112 can include the set-top box device 102, the satellite dish 104, a display device 114, a network interface device (not shown), and a residential gateway (not shown) with a built-in very-high-bit-rate digital subscriber loop (VDSL) modem or optical network termination. The customer premises 112 can receive television content from the television content satellite 110 via the satellite dish 104, and can receive Internet protocol video streams and Internet protocol data streams from the Internet head-end office 108 via the private network 106 and the VDSL modem.

The set-top box device 102 is in communication with the satellite dish 104 via an internal network, such as a coaxial cable network. The set-top box 102 is also in communication with the display device 114 via a video cable such as a coaxial cable, a composite video cable, a Super video (S-video) cable, a component video cable, a High-Definition Multimedia Interface (HDMI) cable and the like. The set-top box device 102 is in communication with the IP head-end office 108 via the private network 106. The set-top box device 102 can receive television content from the television content satellite 110 via the satellite dish 104, and can output the television content to the display device 114. Additionally, the set-top box device 102 can receive data streams and video streams from the IP head-end office 108 via the private network 106, and can output the video streams to the display device 114.

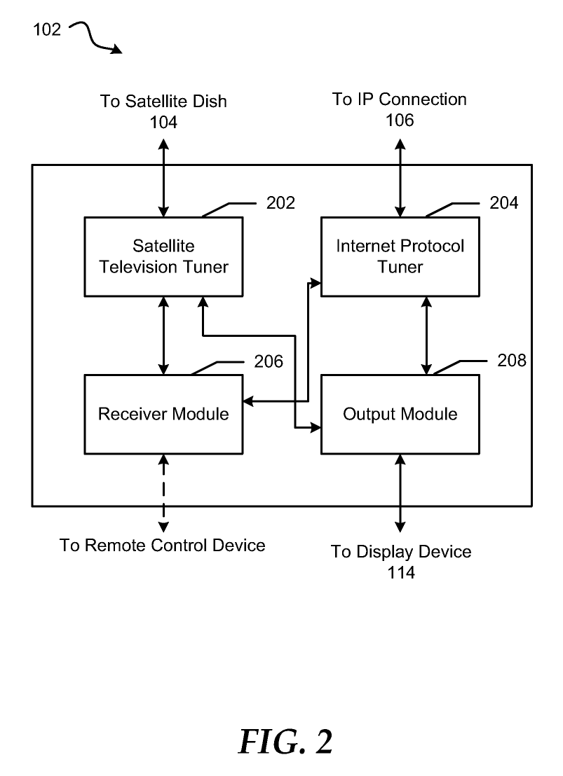

FIG. 2 shows a block diagram of the set-top box device 102 including a satellite television tuner 202, an Internet protocol tuner 204, a receiver module 206, and an output module 208. The satellite tuner 202 is in communication with the satellite dish 104, the receiver module 206, and the output module 208. The Internet protocol tuner 204 is in communication with the private network 106, the receiver module 206, and the output module 208. The receiver module 206 is also in communication with a remote control device (not shown). The output module 208 is also in communication with the display device 114.

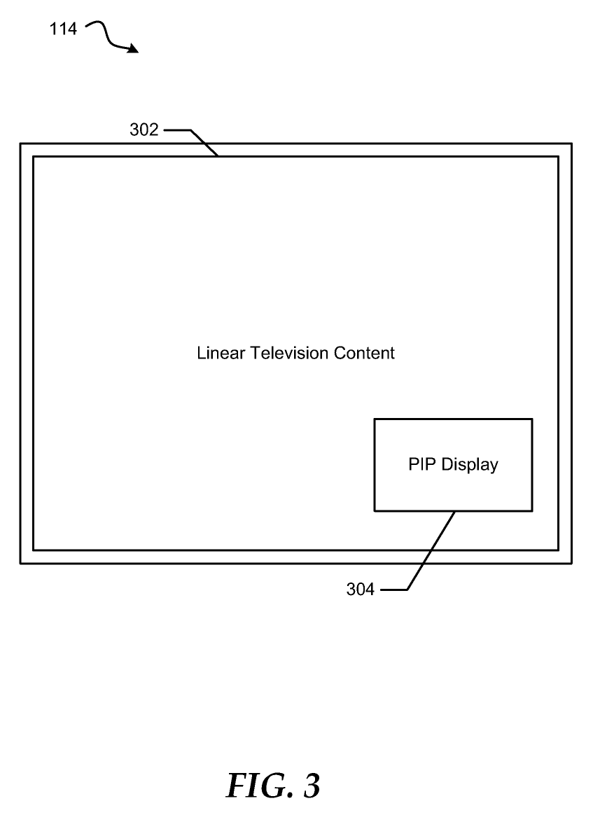

The user of the set-top box 206 can request that the satellite television tuner 202 request and receive television content from the satellite dish 104, and request that the output module 208 output the television content to the display device 114. The television content can be linear television content, such that the television content is broadcast at a predetermined time. The linear television content can be a news broadcast, a live sporting event, a new episode of a television series, and the like. Additionally, the linear television content can be sent as a continuous video stream by the satellite dish 104 to the display device 114, as opposed to a video stream that has been downloaded and cached by the set-top box device 102 for later display. Upon receiving a television channel request from the remote control device, the receiver module 206 can send the request to the satellite tuner 202 for the corresponding channel from the television content satellite 110 via the satellite dish 104. The satellite television tuner 202 can receive and decode the specific television content, so that the set-top box device 102 and the display device 114 can perform different functions on the television content. The television content can then be sent to the display device 114 via the output module 208. The display device 114 can present the television content to the user on a screen 302 as shown in FIG. 3.

The satellite television tuner 202 can process one video stream at a time. Thus, if the user requests a new channel of television content to be displayed on the screen 302, the satellite television tuner 202 can stop processing of the original video stream and can begin to process a new video stream from the satellite dish 104. Upon decoding the new video stream, the satellite television tuner 202 sends the video stream to the output module 208 to be output to the display device 114.

If the user wants to continue viewing the current television content on the screen 302 but browse the other available television channels, the user can request that a small video display be presented on the display device 114 such as a picture-in-picture (PIP) display 304 as shown in FIG. 3. The PIP display 304 can be presented at various locations on the screen 302 as is well known. The PIP display 304 preferably displays an output from the Internet protocol tuner 204. The Internet protocol tuner 204 can receive an Internet protocol video stream from the IP head-end office 108, and can process the video stream for use by the set-top box device 102. The output module 208 can send the video stream to the display device 114 to be presented in the PIP display 304. The Internet protocol video stream received by the Internet protocol tuner 204 can have a lower resolution and lower bandwidth than the video stream received by the satellite television tuner 202, so that the VDSL connection of the residential gateway can accommodate the bandwidth of the Internet protocol video stream. The size of the PIP display 304 can allow the resolution of the Internet protocol video stream to be lower than the resolution of the video stream received by the satellite television tuner 202 without affecting the quality of the television content viewed by the user.

Upon the user sending a PIP request for a specific Internet protocol television channel to the receiver module 206 via the remote control device, the receiver module can send the request for the corresponding channel to the Internet protocol tuner 204. When the Internet protocol tuner 204 receives the request, the Internet protocol tuner can access the IP head-end office 108 via the private network 106 to receive the desired television program. The IP head-end office 108 can receive a video stream associated with the specific Internet protocol television channel from an Internet protocol television system in communication with the head-end office. The Internet protocol television tuner 204 can receive the Internet protocol video stream associated with the requested channel of television content, and the output module 208 can send the video stream to the PIP display 304 to be presented to the user.

If a PIP channel change request is received, the Internet protocol tuner 204 can stop processing a current Internet protocol video stream and start processing a new Internet protocol video stream associated with the PIP channel change request. The new Internet protocol video stream is then output to the display device 114 and presented in the PIP display 304. If the user finds television content that he would like to view on the screen 302, while browsing through different television channels on the PIP display 304, the user can send a channel swap request to the receiver module 206. The channel swap request can cause the satellite television tuner 202 to process a video stream, received from the satellite dish 104, corresponding to the television content that was previously presented in the PIP display 304. Additionally, the Internet protocol tuner 204 can process an Internet protocol video stream, received from the IP head-end office 108, corresponding to the linear television content that was previously presented on the screen 302. Thus, upon the set-top box device 102 receiving the channel swap request, the television content presented on the PIP display 304 can be swapped with the television content displayed on the screen 302.

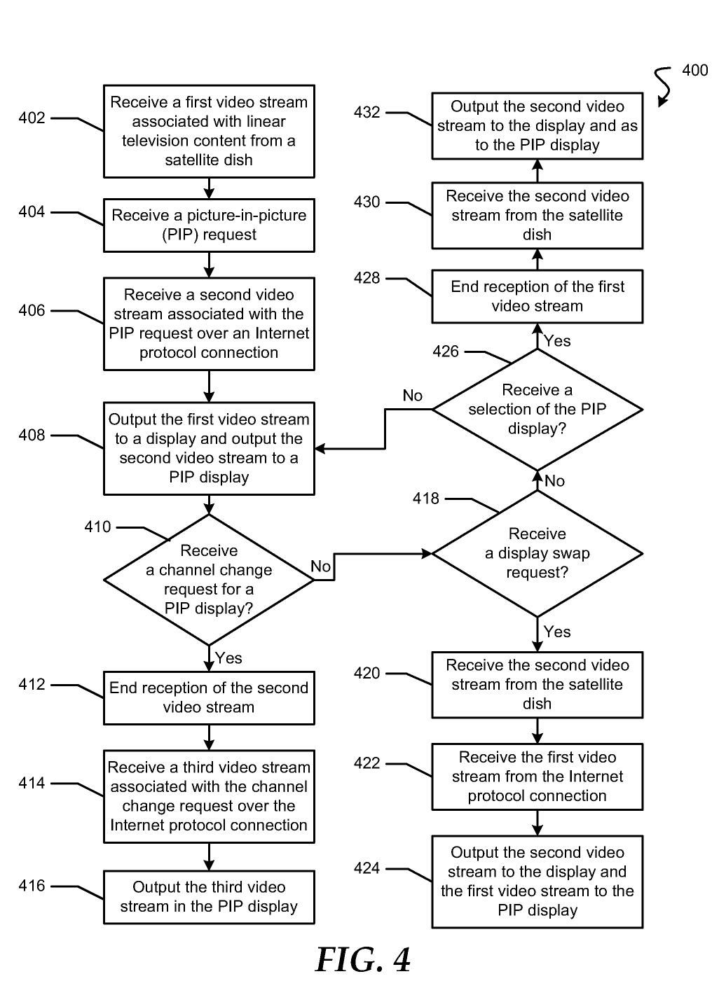

The set-top box device 102 can receive and output television content from both the satellite dish 104 and the IP head-end office 108. FIG. 4 shows a flow diagram of a method 400 for receiving both satellite linear television content and Internet protocol television content at the set-top box device. At block 402, a first video stream associated with linear television content is received from a satellite dish. A PIP request is received at block 404. At block 406, a second video stream associated with the PIP request is received over an Internet protocol connection. The first video stream is output as a linear television content to a display, and the second video stream is output to a PIP display at block 408. At block 410, a determination is made whether a channel change request is received for the PIP display.

If the channel change request for the PIP display is received, reception of the second video stream is ended at block 412. At block 414, a third video stream associated with the channel change request is received over the Internet protocol connection. The third video stream is output to the PIP display at block 416. If the channel change request for the PIP display is not received, a determination is made whether a display swap request is received at block 418. If the display swap request is received, the second video stream is received from the satellite dish at block 420. At block 422, the first video stream is received from the Internet protocol connection. The second video stream is output as linear television content to the display, and the first video stream is output as PIP television content to the PIP display at block 424. At block 426, if the display swap request is not received, a determination is made whether a selection of the PIP display is received. If the selection of the PIP display is not received, the flow diagram continues as stated above at block 408. If the selection of the PIP display is received, the reception of the first video stream is ended at block 428. The second video stream is received from the satellite dish at block 430. At block 432, the second video stream is output as linear television content to the display, and as PIP television content to the PIP display.

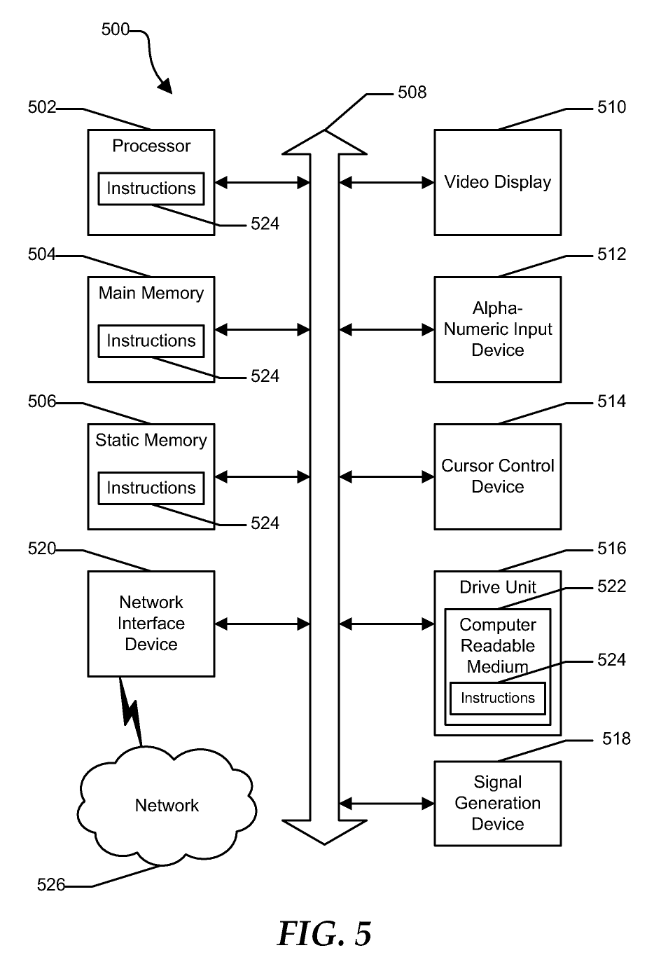

FIG. 5 shows an illustrative embodiment of a general computer system 500 in accordance with at least one embodiment of the present disclosure. The computer system 500 can include a set of instructions that can be executed to cause the computer system to perform any one or more of the methods or computer based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

The computer system 500 may include a processor 502, e.g., a central processing unit (CPU), a graphics processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), an organic light emitting diode (OLED), a flat panel display, a solid state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media. The network interface device 520 can provide connectivity to a network 526, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method comprising:
receiving a first video stream associated with linear television content from a satellite dish;
receiving a second video stream over an Internet protocol connection; and
outputting the first video stream of linear television content received from the satellite dish to a display, and outputting the second video stream received from the Internet protocol connection to a picture-in-picture display on the display.

2. The method of claim 1 further comprising:
receiving a channel change request for the picture-in-picture display;
ending reception of the second video stream;
receiving a third video stream in response to the channel change request over the Internet protocol connection; and
outputting the third video stream in the picture-in-picture display.

3. The method of claim 1 further comprising:
receiving a display swap request;
receiving the second video stream from the satellite dish;
receiving the first video stream from the Internet protocol connection; and
outputting the second video stream as linear television content to the display, and outputting the first video stream to the picture-in-picture display in response to the display swap request.

4. The method of claim 1 wherein the first video stream has a first bit rate higher than a second bit rate of the second video stream.

5. A method comprising:
receiving a first video stream associated with linear television content from a satellite dish;
receiving a picture-in-picture request;
receiving a second video stream over an Internet protocol connection in response to the picture-in-picture request;
outputting the first video stream of linear television content received from the satellite dish to a display; and
outputting the second video stream received from the Internet protocol connection to a picture-in-picture display on the display.

6. The method of claim 5 further comprising:
receiving a channel change request for the picture-in-picture display;
ending reception of the second video stream;
receiving a third video stream associated with the channel change request over the Internet protocol connection; and
outputting the third video stream in the picture-in-picture display.

7. The method of claim 5 further comprising:
receiving a display swap request;
receiving the second video stream from the satellite dish;
receiving the first video stream from the Internet protocol connection; and
outputting the second video stream as linear television content to the display, and outputting the first video stream to the picture-in-picture display in response to the display swap request.

8. The method of claim 5 wherein the first video stream has a first bit rate higher than a second bit rate of the second video stream.

9. A set-top box device comprising:
a satellite television tuner configured to receive a first video stream associated with linear television content from a satellite dish, and configured to output the first video stream to a display; and
an Internet protocol television tuner configured to receive a second video stream from an Internet protocol connection, and configured to output the second video stream to a picture-in-picture display on the display.

10. The set-top box device of claim 9 further comprising:
a receiver module in communication with the Internet protocol television tuner, the receiver configured to receive a picture-in-picture request from a remote control device and further configured to send the picture-in-picture request to the Internet protocol television tuner.

11. The set-top box device of claim 9 wherein the Internet protocol television tuner is further configured to receive and to output a third video stream in response to a picture-in-picture channel change request.

12. The set-top box device of claim 9 wherein the Internet protocol television tuner is further configured to receive and to output the first video stream in response to a display swap request, and the satellite television tuner is further configured to receive and to output second video stream in response to the display swap request.

13. A computer readable medium comprising a plurality of instructions to manipulate a processor, the plurality of instructions comprising:
instructions to receive a first video stream associated with linear television content from a satellite dish;
instructions to receive a picture-in-picture request;
instructions to receive a second video stream over an Internet protocol connection in response to the picture-in-picture request; and
instructions to output the first video stream of linear television content received from the satellite dish to a display, and to output the second video stream received from the Internet protocol connection to a picture-in-picture display on the display.

14. The computer readable medium of claim 13 further comprising:
instructions to receive a channel change request for the picture-in-picture display;
instructions to end reception of the second video stream;
instructions to receive a third video stream associated with the channel change request over the Internet protocol connection; and
instructions to output the third video stream in the picture-in-picture display.

15. The computer readable medium of claim 13 further comprising:
instructions to receive a display swap request;
instructions to receive the second video stream from the satellite dish;
instructions to receive the first video stream from the Internet protocol connection; and
instructions to output the second video stream as linear television content to the display, and outputting the first video stream to the picture-in-picture display in response to the display swap request.

16. The computer readable medium of claim 13 wherein the first video stream has a first bit rate greater than a second bit rate of the second video stream.

17. A method comprising:
receiving a first video stream having a first bit rate, the first video stream being associated with linear television content from a satellite dish;
receiving a second video stream over an Internet protocol connection via a Internet protocol television tuner, the second video stream having a second bit rate lower than the first bit rate; and
outputting the first video stream of linear television content received from the satellite dish to a display, and outputting the second video stream received from the Internet protocol connection to a picture-in-picture display on the display.

18. The method of claim 1 further comprising:
receiving a channel change request for the picture-in-picture display;
ending reception of the second video stream;
receiving a third video stream in response to the channel change request over the Internet protocol connection; and
outputting the third video stream in the picture-in-picture display.

19. The method of claim 1 further comprising:
receiving a display swap request;
receiving the second video stream from the satellite dish;
receiving the first video stream from the Internet protocol connection; and
outputting the second video stream as linear television content to the display, and outputting the first video stream to the picture-in-picture display in response to the display swap request.
